(19) United States
(12) Patent Application Publication
(10) Pub. No.: US 2020/0141463 A1
(43) Pub. Date: May 7, 2020

(54) METHOD OF PRODUCING COIL SPRING

(71) Applicant: NHK Spring Co., Ltd., Kanagawa (JP)

(72) Inventors: Masaru Matsubara, Kanagawa (JP); Suguru Kajigaya, Kanagawa (JP)

(21) Appl. No.: 16/727,811

(22) Filed: Dec. 26, 2019

Related U.S. Application Data
(63) Continuation of application No. 15/562,793, filed on Sep. 28, 2017.

(30) Foreign Application Priority Data
Mar. 31, 2015 (JP) 2015-072496

(51) Int. Cl. F16F 1/02; C21D 9/02; F16F 1/06; B21F 3/02; B21F 35/00; F16F 1/04

(52) U.S. Cl. CPC F16F 1/021; C21D 9/02; F16F 1/06; B21F 3/02; F16F 2226/00; F16F 1/04; F16F 2228/007; F16F 1/047; B21F 35/00

(57) ABSTRACT

A method of producing a coil spring including a part of high hardness and a softening part of lower hardness than the part, the method including: a step of heating a wire rod; a step of forming the wire rod heated into a spiral shape; a step of quenching and tempering the wire rod spirally formed; and a step of carrying out electrical heating to a part that is the softening part on the wire rod quenched and tempered, with a pair of electrodes applied to both faces of the softening part.

### CROSS REFERENCE TO RELATED APPLICATION

This application is a continuation of U.S. patent application Ser. No. 15/562,793, filed Sep. 28, 2017, which was a US national phase of International Application No. PCT/JP2016/058270, filed Mar. 16, 2016, which claims priority to Japanese Application No. 2015-072496, filed Mar. 31, 2015. The priority applications, U.S. Ser. No. 15/562,793, PCT/JP2016/058270, and JP 2015-072496, are hereby incorporated by reference.

### TECHNICAL FIELD

1 The present invention relates to method of producing a coil spring.

### BACKGROUND ART

In conventional art, a compression spring such as a coil spring that is used in a vehicle or the like has required increasing hardness thereof from the viewpoint of weight saving thereof and improvement in durability thereof. In view of this, increasing the hardness of the compression spring has generally been carried out.

### CITATION LIST

### Patent Literature

Patent Literature 1: Japanese Unexamined Patent Application Publication No. 2010-255759

### SUMMARY OF THE INVENTION

### Technical Problem

Incidentally, when the hardness of a compression spring is increased, there is a high possibility that corrosion and breakage occur accordingly.

Possible causes of the breakage of a compression spring used in a vehicle include contact of a spring seat with the compression spring, contact of adjacent portions of an element wire of the compression spring with each other, and wear and peel-off of a coating due to external factors (chipping or the like). This causes the base of the compression spring to be exposed, allowing breakage due to corrosion or flaw to occur.

It is supposed that corrosion and breakage occur through a process such as follows.

A part of the compression spring strongly abuts on or is rubbed against itself and/or a mating component, thereby allowing a coating on the part to be peeled off. Then, the part where the coating is peeled off is rusted, allowing a corrosion pit to be generated in the rusted part. Then, concentration of stress on the corrosion pit causes breakage to occur from the part concerned.

As described above, in the present circumstances, the hardness of a coil spring has been increased from the viewpoint of demand for weight saving in terms of environment and cost, while notch sensitivity of the coil spring has become high, leading to a high possibility of corrosion and breakage of the coil spring.

The present invention is made in view of the above actual situation and an object of the invention is to provide a coil spring having improved durability and high reliability.

### Solution to Problem

In order to solve the problems described above, the present invention provides, as one aspect thereof, a method of producing a coil spring including a part of high hardness and a softening part of lower hardness than the part, the method including: a step of heating a wire rod; a step of forming the wire rod heated into a spiral shape; a step of quenching and tempering the wire rod spirally formed; and a step of carrying out electrical heating to a part that is the softening part on the wire rod quenched and tempered, with a pair of electrodes applied to both faces of the softening part.

891012345678Advantageous Effects of the Invention

The present invention makes it possible to realize a method of producing a coil spring having improved durability and high reliability.

### BRIEF DESCRIPTION OF DRAWINGS

FIG. 1 is a front view showing a state of use of a compression spring according to a first embodiment of the present invention.

FIG. 2 is a front view showing a first state of use of a compression spring according to a second embodiment of the present invention.

FIG. 3 is a front view showing a second state of use of the compression spring according to the second embodiment.

FIG. 4 is a graph representing the relation between a spring travel and a load of the compression spring whose spring constant changes.

FIG. 5A is a view showing an example of high frequency induction heating being carried out at a softening part N1.

FIG. 5B is a view showing an example of high frequency induction heating being carried out at a softening part N2.

FIG. 6A is a view showing an example of electrical heating being carried out at the softening part N1.

FIG. 6B is a view showing an example of electrical heating being carried out at the softening part N2.

FIG. 7 is a diagram showing a process of a first method of hot forming.

FIG. 8 is a diagram showing a process of a second method of hot forming.

FIG. 9 is a diagram showing a process of cold forming.

### DESCRIPTION OF EMBODIMENTS

Embodiments of the present invention will be hereinafter described in detail with reference to the drawings as appropriate.

### First Embodiment

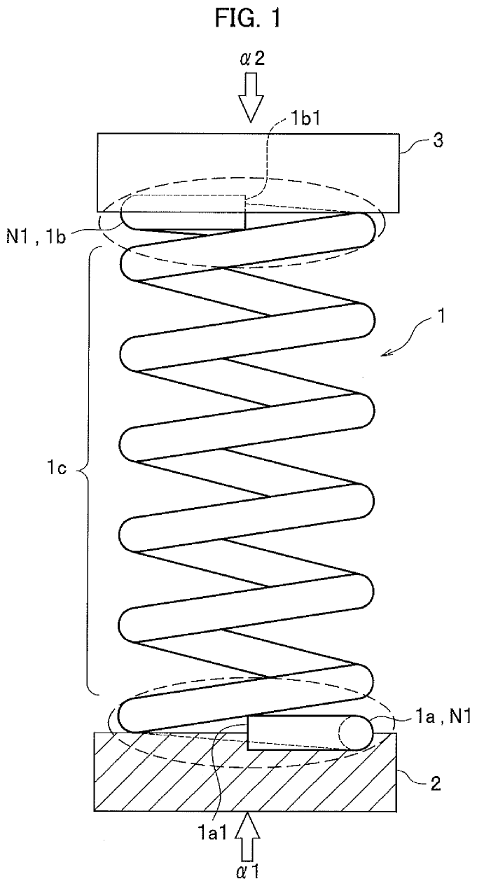

FIG. 1 is a front view showing a state of use of a compression spring according to a first embodiment of the present invention.

A compression spring 1 according to the first embodiment includes a lower end turn part 1a and an upper end turn part 1b, and an effective part 1c lying between the lower end turn part 1a and the upper end turn part 1b.

The lower end turn part 1a is a part that is attached to one side of the compression spring 1, and does not contribute to spring action.

The upper end turn part 1b is a part that is attached to the other side of the compression spring 1, and does not contribute to the spring action.

The effective part 1c is a part that exerts the spring action of the compression spring 1, and a part whose spring constant is determined.

The compression spring 1 is formed to allow the effective part 1c to have a spiral shape, for example, using spring steel. Examples of the spring steel that can be used include SUP3, SUP6, SUP7, SUP9, SUP9A, SUP10, SUP11A, SUP12 and SUP13 that are defined in the Japanese Industrial Standards (JIS) G 4801:2005.

The compression spring 1 is attached to be fitted in a lower spring seat 2 and an upper spring seat 3.

The lower spring seat 2 is formed of rubber, resin, metal, or the like. The lower spring seat 2 is configured to allow an edge 1a1 of the lower end turn part 1a of the compression spring 1 to be locked thereby, and to allow a part or the whole of the lower end turn part 1a to be housed therein.

Similarly, the upper spring seat 3 is formed of rubber, resin, metal, or the like. The upper spring seat 3 is configured to allow an edge 1b1 of the upper end turn part 1b of the compression spring 1 to be locked thereby, and to allow a part or the whole of the upper end turn part 1b to be housed therein.

The compression spring 1 is adapted to receive a load in the direction of compression (outlined arrows a1, a2 in FIG. 1) from the lower spring seat 2 and the upper spring seat 3, to be used.

The compression spring 1 is adapted to receive the load in the direction of compression to compressively deform, and to apply an extension force (elastic force) according to the amount of deformation to the upper spring seat 3 and the lower spring seat 2.

In this case, the lower end turn part 1a and the upper end turn part 1b of the compression spring 1 are pressed against the lower spring seat 2 and the upper spring seat 3, respectively, with the load according to the amount of compressive deformation of the compression spring 1.

Consequently, the lower end turn part 1a and the upper end turn part 1b are rubbed against the lower spring seat 2 and the upper spring seat 3 in deformation motion of the compression spring 1. The lower end turn part 1a and the upper end turn part 1b produce the same phenomenon, and thus description will be given below, taking the lower end turn part 1a as an example.

As described above, the lower end turn part 1a is rubbed against the lower spring seat 2 to allow a coating thereon to be easily peeled off. When the coating is peeled off at the contact part of the lower end turn part 1a with the lower spring seat 2, the part where the coating is peeled off is rusted to cause corrosion, allowing a corrosion pit to be generated. Accordingly, stress concentration occurs in the corrosion pit, and where the lower end turn part 1a is high in hardness, notch sensitivity thereof is also high. For that reason, there is a possibility that the stress concentration on the corrosion pit causes fissures of the lower end turn part 1a to progress, leading to breakage. The upper end turn part 1b is also the same as the lower end turn part 1a.

In view of the above, the first embodiment (of the present invention) allows the hardness of the lower end turn part 1a and the hardness of the upper end turn part 1b to be made lower than the hardness of other parts of the compression spring 1, thereby lowering the notch sensitivity to suppress progress of fissures in the corrosion pit.

That is, the compression spring 1 according to the first embodiment allows the hardness of the parts (the lower end turn part 1a and the upper end turn part 1b) that come into contact with the lower spring seat 2 and the upper spring seat 3 to be made relatively low, thereby lowering the notch sensitivity.

The lower end turn part 1a is a part formed with the number of turns of, e.g., approximately 0.6 to 0.7. A part of the lower end turn part 1a coming into contact with the lower spring seat 2 is at least softened, thereby lowering the notch sensitivity.

The upper end turn part 1b is a part formed with the number of turns of, e.g., approximately 0.6 to 0.7. A part of the upper end turn part 1b coming into contact with the upper spring seat 3 is at least softened, thereby lowering the notch sensitivity.

The lower end turn part 1a and the upper end turn part 1b of the compression spring 1 are each defined as a softening part N1.

This makes it possible to suppress occurrence of breakages in the lower end turn part 1a and the upper end turn part 1b of the compression spring 1, and to achieve long life of the compression spring 1 to enhance reliability thereof.

### Second Embodiment

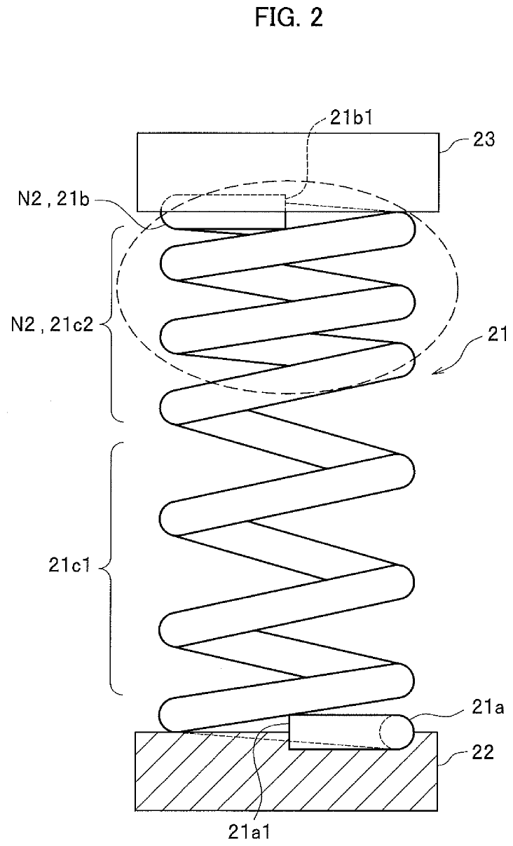

FIG. 2 is a front view showing a first state of use of a compression spring according to a second embodiment of the present invention.

A compression spring 21 according to the second embodiment is a compression spring whose spring constant changes during use.

In general, when the spring constant of a compression spring is relatively great, the amount of deformation with respect to a load becomes small. For that reason, there is a case where it is desirable that the amount of deformation of the compression spring is made different between when the load is small and when the load is great.

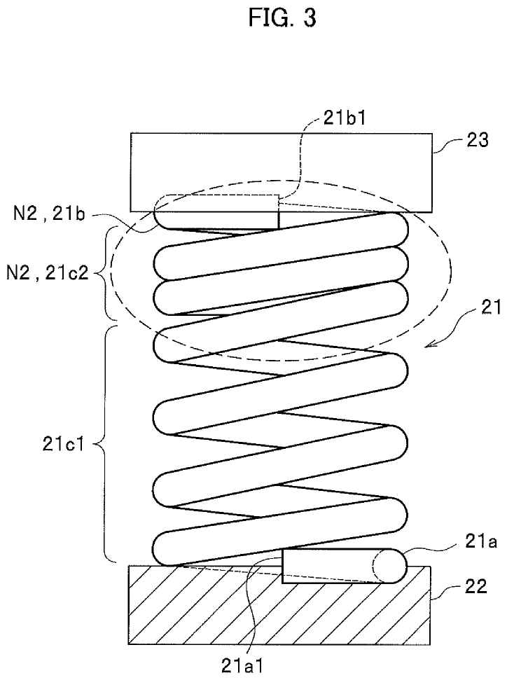

For example, when no load is put on a truck, the compression spring 21 is used in the state shown in FIG. 2, and when a heavy load is put on the truck, the compression spring 21 is used in the state shown in FIG. 3. FIG. 3 is a front view showing a second state of use of the compression spring according to the second embodiment.

The compression spring 21 includes an upper end turn part 21b and a lower end turn part 21a, and a first effective part 21c1 and a second effective part 21c2 lying between the lower end turn part 21a and the upper end turn part 21b.

The upper end turn part 21b is a part that is attached to one side of the compression spring 21, and does not contribute to spring action.

The lower end turn part 21a is a part that is attached to the other side of the compression spring 21, and does not contribute to the spring action.

The first effective part 21c1 is a compression spring part whose spring constant k1 is greater than a spring constant k2 of the second effective part 21c2. The first effective part 21c1 is formed to allow a winding pitch thereof to be wider than that of the second effective part 21c2.

The second effective part 21c2 is a compression spring part whose spring constant k2 is smaller than the spring constant k1 of the first effective part 21c1. The second effective part 21c2 is formed to allow a winding pitch thereof to be narrower than that of the first effective part 21c1.

The compression spring 21 is formed to allow the first effective part 21c1 and the second effective part 21c2 to have a spiral shape, for example, using spring steel in the same way as in the first embodiment. Examples of the spring steel that can be used include the same ones as those in the compression spring 1.

The compression spring 21 is attached to be fitted in a lower spring seat 22 and an upper spring seat 23.

The lower spring seat 22 is formed of rubber, resin, metal, or the like. The lower spring seat 22 is configured to allow an edge 21a1 of the lower end turn part 21a of the compression spring 21 to be locked thereby, and to allow a part or the whole of the lower end turn part 21a to be housed therein.

Similarly, the upper spring seat 23 is formed of rubber, resin, metal, or the like. The upper spring seat 23 is configured to allow an edge 21b1 of the upper end turn part 21b of the compression spring 21 to be locked thereby, and to allow a part or the whole of the upper end turn part 21b to be housed therein.

Next, description will be given of spring characteristics of the compression spring 21.

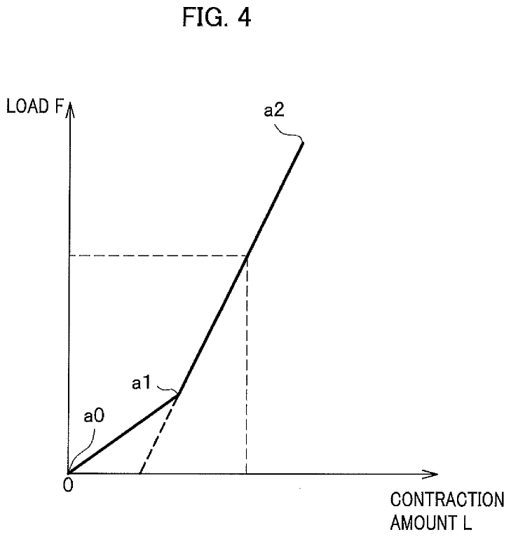

FIG. 4 is a graph representing the relation between a spring travel and a load of the compression spring whose spring constant changes.

For the a0-a1 section shown in FIG. 4, the first effective part 21c1 and the second effective part 21c2 compressively deform as shown in FIG. 2.

When the load is denoted by F; the total amount of contraction of the compression spring 21 is denoted by L; the contraction amount of the first effective part 21c1 is denoted by L1; and the contraction amount of the second effective part 21c2 is denoted by L2, the following expression is obtained.

L=L1+L2

From the Hooke's law, the expression of F=k×L is obtained, and from the example shown in FIG. 4 including the first effective part 21c1 and the second effective part 21c2, the following expressions are obtained.

F=k1×L1, F=k2×L2

Rearranging the following expression:

L=L1+L2=(F/k1)+(F/k2)=F×((k1+k2)/k1k2)),

the following expression is obtained.

F=(k1×k2/(k1+k2))×L

Therefore, the spring constant K for the a0-a1 section is expressed as follows:

K=k1×k2/(k1+k2)

For the a1-a2 section shown in FIG. 4, the second effective part 21c2 is brought into a closely contacted state in itself as shown in FIG. 3 and thus does not function, and thus only the first effective part 21c1 functions.

When the load is denoted by F and the total amount of contraction of the compression spring 21 is denoted by L, the following expression is obtained.

F=k1×L

Therefore, the spring constant K for the a1-a2 section shown in FIG. 4 is expressed as follows:

K=k1

Incidentally, for the a1-a2 section shown in FIG. 4, the second effective part 21c2 allows adjacent portions of a wire rod thereof to come into contact with each other.

Consequently, at the time of compressive deformation of the compression spring 21, the adjacent portions of the wire rod of the second effective part 21c2 are rubbed against each other to allow a coating thereon to be easily peeled off. When the coating on the wire rod of the second effective part 21c2 is peeled off, as described above, the part where the coating is peeled off is rusted to cause corrosion, allowing a corrosion pit to be generated and allowing stress concentration to occur in the corrosion pit. At that time, when the second effective part 21c2 is high in hardness, notch sensitivity thereof is also high. For that reason, there is a possibility that the stress concentration on the corrosion pit in the second effective part 21c2 causes fissures to progress, leading to breakage of the second effective part 21c2.

In view of the above, the second embodiment (of the present invention) allows the hardness of the second effective part 21c2 in addition to the lower end turn part 21a and the upper end turn part 21b to be made lower than the hardness of other parts of the compression spring 21, thereby lowering the notch sensitivity to suppress progress of fissures in the corrosion pit. Therefore, the second embodiment allows the hardness of the part where the adjacent portions of the wire rod of the compression spring 21 come into contact with each other, to be made lower, thereby lowering the notch sensitivity.

That is, the compression spring 21 according to the second embodiment allows the hardness of the parts (the lower end turn part 21a and the upper end turn part 21b) that come into contact with the lower spring seat 22 and the upper spring seat 23, and the part (the second effective part 21c2) where the adjacent portions of the wire rod of the compression spring 21 come into contact with each other, to be made lower, thereby lowering the notch sensitivity.

This makes it possible to suppress occurrence of breakage in the lower end turn part 21a, the upper end turn part 21b and the second effective part 21c2 of the compression spring 21, and to achieve long life of the compression spring 21 to enhance reliability thereof.

Of the lower end turn part 21a, the upper end turn part 21b and the second effective part 21c2 that are to be softened in the compression spring 21, the upper end turn part 21b and the second effective part 21c2 are each defined as a softening part N2 for convenience of explanation.

### Softening Treatment of the Softening Parts N1, N2 in the First and Second Embodiments

Next, description will be given of the outline of softening treatment of the softening parts N1, N2 in the first and second embodiments.

Regardless of whether cold forming or hot forming is applied to the element wire (wire rod) of the compression spring 1, 21, the softening treatment of the softening parts N1, N2 is carried out as follows. The softening treatment of the softening parts N1 and the softening treatment of the softening parts N2 are similar to each other, and thus description is given below, taking the softening parts N1 as an example.

The compression spring 1 spirally coiled is quenched and tempered. Then, only the softening parts N1 are further tempered.

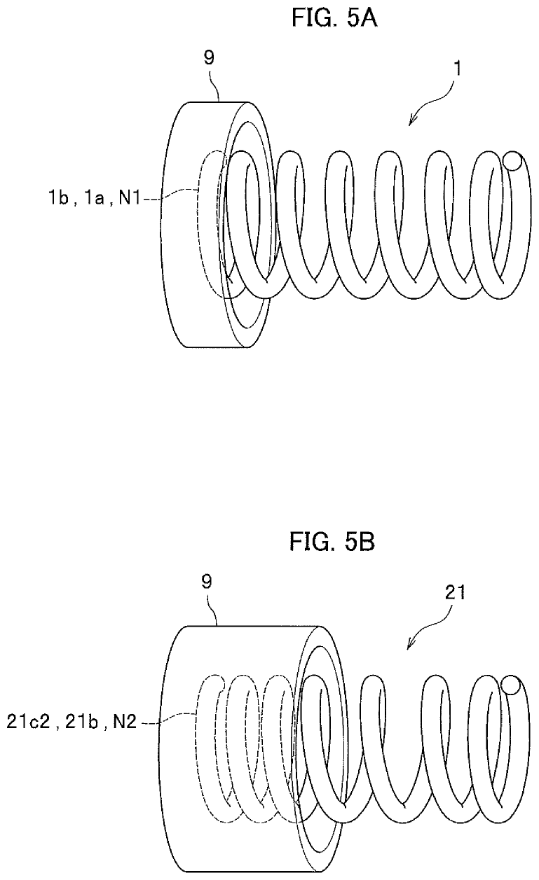

As for tempering of the softening at the softening part N1, as shown in FIG. 5A, the softening part N1 is inserted into and heated by a high frequency heating device 9. Similarly, as shown in FIG. 5B, the softening part N2 is inserted into and heated by the high frequency heating device 9. FIG. 5A shows an example of the high frequency induction heating being carried out at the softening part N1, and FIG. 5B shows an example of the high frequency induction heating being carried out at the softening part N2.

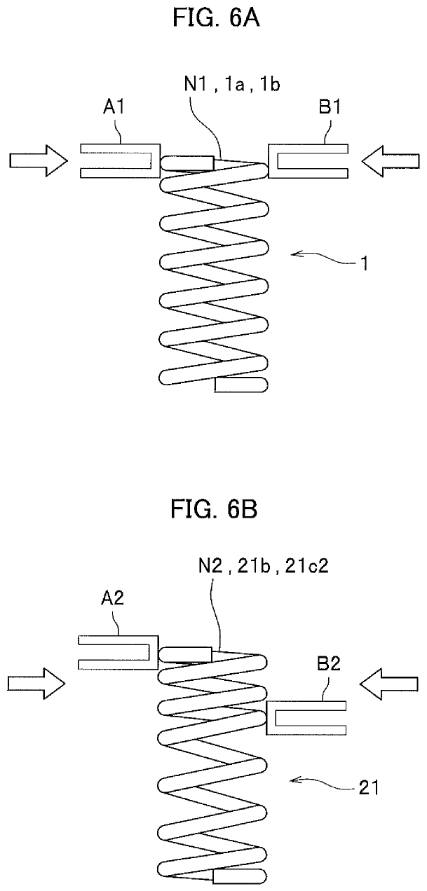

Alternatively, as shown in FIG. 6A, electrical heating is carried out to the softening part N1 with a pair of electrodes A1, B1 applied to both faces of the softening part N1. Similarly, as for tempering of the softening at the softening part N2, as shown in FIG. 6B, electrical heating is carried out to the softening part N2 with a pair of electrodes A2, B2 applied to both faces of the softening part N2. FIG. 6A shows an example of the electrical heating being carried out at the softening part N1, and FIG. 6B shows an example of the electrical heating being carried out at the softening part N2.

Note that the lower end turn part 21a which is the softening part of the compression spring 21 is heated in a similar manner to that in FIG. 5A or FIG. 6A.

Heating equipment for the above electrical heating system or the high frequency induction heating system has a simple structure and a good universal use, thus making it possible to suppress equipment cost.

Further, concrete description will be given of the softening treatment of the softening parts N1, N2, inclusive of forming of the compression spring 1 and the compression spring 21. As described above, the softening treatment of the softening parts N1 and the softening treatment of the softening parts N2 are carried out in a similar manner, and thus description is given below, taking the softening parts N1 as an example.

First, description will be given of a case where hot forming is carried out using the element wire (wire rod) to which cold forming has been applied.

### <First Method of Hot Forming>

A first method of hot forming is carried out as follows.

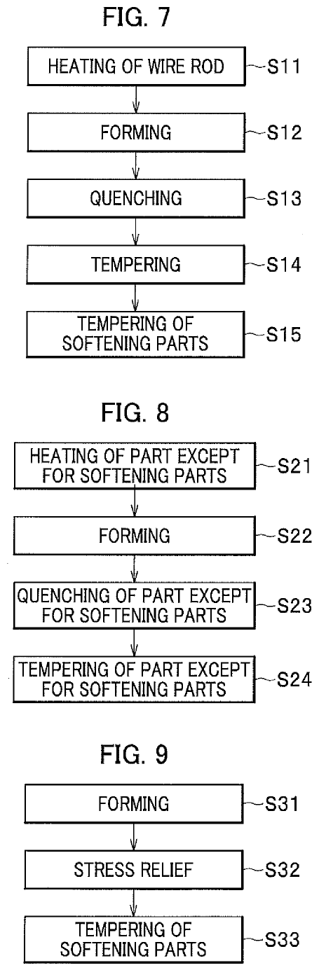

FIG. 7 is a diagram showing a process of the first method of hot forming.

First, a straight wire rod made of spring steel is heated at around 950 degrees Celcius for about 9 minutes in the heating device (step S11 in FIG. 7).

Then, the heated wire rod is formed into a spiral shape by a coiling machine (step S12).

Then, the wire rod spirally formed is immersed in oil to be rapidly cooled to about 50 degrees Celcius for quenching (step S13). Thereafter, the oil adhering to the wire rod is washed away, and the spiral wire rod quenched is heated at around 450 degrees Celcius and then slowly cooled in water to be tempered (step S14).

Then, as shown in FIG. 5A and FIG. 6A, partial tempering of only the softening parts N1 is carried out at a temperature higher than that of the tempering in step S14 (step S15).

Thereafter, shot peening, powder coating, and baking of a coating material at around 200 degrees Celcius with furnace heating or the like, are carried out.

The above process allows the compression spring 1 to be obtained, in which the hardness of the softening parts N1 (the lower end turn part 1a and the upper end turn part 1b) is made lower than the hardness of other parts, thereby lowering the notch sensitivity.

<Second Method of Hot Forming>

A second method of hot forming is carried out as follows.

FIG. 8 is a diagram showing a process of the second method of hot forming.

A part except for the softening parts N1, of a straight wire rod made of spring steel is heated at around 950 degrees Celcius for about 9 minutes (step S21 in FIG. 8).

Then, the above wire rod is formed into a spiral shape by a coiling machine (step S22).

Then, the wire rod spirally formed is immersed in oil to be rapidly cooled to about 50 degrees Celcius for quenching of the part except for the softening parts N1 (step S23). Thereafter, the oil adhering to the wire rod is washed away, and the spiral wire rod quenched except for the softening parts N1 is heated at around 450 degrees Celcius and then slowly cooled in water to be tempered (step S24).

Thereafter, shot peening, powder coating, and baking of a coating material are carried out.

The above method does not require quenching and tempering of the softening parts N1, and allows the compression spring 1 to be obtained, in which the hardness of the softening parts N1 is made lower than the hardness of other parts, thereby lowering the notch sensitivity.

Note that, although in the above second method of hot forming, description is given of the case where quenching and tempering of the softening parts N1 are not carried out, a configuration may be adopted in which the softening parts N1 are quenched a little to form a part of the highest hardness (other than the softening parts N1) and a part of a little low hardness (the softening parts N1).

<Method of Cold Forming>

Next, description will be given of a case where cold forming is carried out using the element wire (wire rod) to which hot forming has already been applied.

FIG. 9 is a diagram showing a process of cold forming.

First, a straight wire rod made of spring steel is formed into a spiral shape by a coiling machine (step S31).

Then, stress relief annealing of the wire rod of a coil shape is carried out (step S32).

Then, as shown in FIG. 5A and FIG. 6A, partial tempering of only the softening parts N1 is carried out at a temperature higher than that of the annealing in step S32 (step S33).

The above process allows the compression spring 1 to be obtained, in which the hardness of the softening parts N1 is made lower than the hardness of other parts, thereby lowering the notch sensitivity.

The softening parts N2 and the lower end turn part 21a which is the softening part, of the compression spring 21, are softened in a similar manner to that described above.

### Third Embodiment

A compression spring according to a third embodiment is a compression spring that applies thereto the technique explained in the first embodiment and the second embodiment so as to allow a breakage part thereof to be specified.

Concretely, the compression spring is partially softened except for a part to be damaged by breaking, thereby allowing the breakage part to be specified.

For example, in a vehicle or the like, partial softening treatment is carried out so as to allow the breakage part to be arranged at a location which is easily identified. Alternatively, in order to allow the breakage part of the compression spring to be received by other parts, a structure (catcher structure) may be adopted in which partial softening is carried out to form a part where breakage occurs, and the part damaged by breaking is received by the other parts.

This makes it possible to identify the breakage part early, to perform early maintenance, and to take safety measures which avoid becoming unable to travel.

The above configuration produces the following advantageous effects.

1. In the compression spring, the hardness of the part that comes into contact with the other member, or the part where the adjacent portions of the wire rod of the compression spring come into contact with each other, is allowed to be made lower than that of the other parts, thereby making it possible to lower the notch sensitivity. Consequently, corrosion and breakage can be suppressed or avoided.
This makes it possible to obtain the compression spring having high durability that can avoid corrosion and breakage.
2. Partially softening the material (for example, SUP7 or the like) having low corrosion durability makes it possible to use the compression spring in a region where salt damage of the compression spring is caused (salt damage region).
3. Adopting the above configuration makes it possible to improve corrosion durability of the compression spring in the salt damage region.
4. Increasing the hardness of the compression spring in which adjacent portions of the element wire come into contact with each other makes it possible to achieve weight saving of the compression spring.
5. Partially softening the compression spring makes it possible to specify the breakage part.
6. Specifying the breakage part of the compression spring as described above makes it possible to arrange a part which does not hinder normal use, as the breakage part in advance, and to suppress influence exerted on the use of the compression spring.

### OTHER EMBODIMENTS

1. Although in the above embodiments, description is given of the compression spring 1, 21 as an example of the coil spring, the present invention may be applied to a tension spring.
2. Although in the above first to third embodiments, description is given of various configurations, a configuration obtained by suitably selecting each configuration to combine together may be adopted.
3. The above first to third embodiments describe one example of the present invention, and a variety of concrete modified embodiments of the present invention are possible within the scope described in the claims or the scope described in the embodiments.

### REFERENCE SIGNS LIST

1, 21: Compression spring (Coil spring)
1a, 21a: Lower end turn part (Part of low hardness)
1b, 21b: Upper end turn part (Part of low hardness)
21c2: Second effective part (Part of low hardness)
A1, B1: A pair of electrodes
A2, B2: A pair of electrodes
N1: Softening part
N2: Softening part

1-12. (canceled)

13. A method of producing a coil spring comprising: including a part of high hardness; and a softening part of lower hardness than the part, the method comprising:
a step of heating a wire rod;
a step of forming the wire rod heated into a spiral shape;
a step of quenching and tempering the wire rod spirally formed; and
a step of carrying out electrical heating to a part that is the softening part on the wire rod quenched and tempered, with a pair of electrodes applied to both faces of the softening part.
